(19) United States
(12) Patent Application Publication
(10) Pub. No.: US 2006/0116925 A1
(43) Pub. Date: Jun. 1, 2006

(54) System and method(s) for marketing by providing information of life in a foreign country and/or area, via CD-ROM, in the airplane and/or any vehicle in a language familiar to the passengers

(75) Inventors: Yoo Seung Kim, Los Angeles, CA (US); Jennifer Hyun-Hi Kim, Los Angeles, CA (US)

Correspondence Address: KIM, YOO SEUNG, 431 SOUTH BURNSIDE AVENUE #3C, LOS ANGELES, CA, 90036, US

(73) Assignees: Yoo Seung Kim, Los Angeles, CA (US); Jennifer Hyun-Hi Kim, Los Angeles, CA (US)

(21) Appl. No.: 10/904,780

(22) Filed: Nov. 29, 2004

(51) Int. Cl. G06Q 30/00

(52) U.S. Cl. 705/14

(57) ABSTRACT

The present invention provides a method(s) for marketing by providing information of life in a foreign country and/or area, including but not limited to advertisements via CD-ROM, in the airplane, other transportation vehicles, and/or terminals, mainly but not limited to international aircrafts transporting international passengers en route to a new country of destination, in a language comfortable for the passenger. All the information that must be stored in this CD-ROM are converted and organized into electronic format to fit and to be transferred to the provided space of the web page style segmentation. This CD-ROM is distributed via 1) the various transportation companies to their passengers for free or minimal cost, and/or 2) agents at the transportation terminals. All the advertisers can provide their advertisement in many different ways including video, audio, picture, graphics, and etc. The above is also converted to a website with the option to download for the purpose of printing and/or transferring to a cellular phone and/or other electronic devices and/or discs.

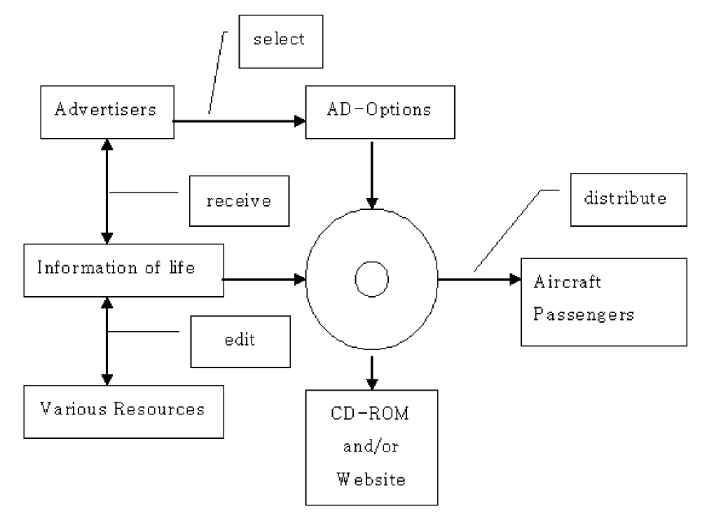

### BACKGROUND-FIELD OF INVENTION

The present invention relates to advertising and providing information. In particular, the present invention relates to the marketing systems and methods for providing contextual advertising information to the passengers in the airplane and/or other transportation systems, and/or persons with interest in an area of travel or possible travel, via a CD-ROM, website with the option to download for the purpose of printing and/or transferring to another electronic device and/or discs, television broadcasting, and etc. by providing information and advertisements of interest in an unfamiliar area(s) of interest or travel.

### BACKGROUND-DISCUSSION OF PRIOR ART

Until now, viewing of advertisements was limited to those who sought out the information via time consuming research, or was limited to the locals in the area of advertisement.

The most popular method of advertisement, the Yellow Pages, limits viewing to those who have access to the Yellow Pages, usually the locals, and must take the time out of one's busy schedule to seek out wanted information. For foreigners however, the search for the Yellow Pages alone can be very frustrating, let alone having to look up wanted information in that directory.

The advertising method in patent 20,040,168,189 to Reynolds, Aug. 26, 2004 addresses television viewers only. One must have access to a television and take the time to sit in front of a television to gain access to the limited advertisements. Also, the viewer must interrupt his or her viewing of other television programs. To the advertisers, they are only reaching a limited number of people, usually those who are already familiar with the business and usually products. Furthermore, this has very little use for those who do not understand the language.

Again, in the advertising method in patent 20,040,163,107 to Crystal, Aug. 19, 2004 addresses television viewers only, with limited viewing. This also has very use for those who do not understand the language.

In the advertising method in patent 20,040,111,938 to Ozawa, Jun. 17, 2004 the advertisers reach those who happen to view the advertisement on the road, when most do not have access to a writing utensil to write down the information, and are most likely to forget about the details of what they saw once they reach their destination.

### OBJECTS AND ADVANTAGES

Accordingly, several objects and advantages of my invention are that this invention is compact and easily portable, and does not take up much space. Furthermore, it is ready to be accessed upon boarding the transportation system. In addition, it makes good use of travel time while in the transportation system which in many cases limits the nature and amount of activity. Moreover, it not only provides advertisements, but information that could be helpful in adjusting to the unfamiliar area. Finally, it is made available to all the passengers in the transportation system, reaching hundreds and/or thousands of people on a daily bases, entering the area of the designated advertisements and information in a language familiar to the passengers. Thus, this invention will be a great advantage not only for the people who are entering an unfamiliar area, but it will also be a great advantage for the advertisers because they will be reaching a much greater volume of possible clients on a daily bases.

### DESCRIPTION OF DRAWING

The drawing is a flow chart of a method of marketing advertisements and providing information via a CD-ROM in the aircraft and/or any vehicle.

| Term | Definition |
|---|---|
| advertisers | Any and all businesses, services, organizations, |
| | agencies, and etc. calling public attention via |
| | this invention |
| various resources | Any and all businesses, services, organizations, |
| | agencies, media, lawyers, people, and etc. who will |
| | provide data/information for this invention |
| Information of life | Any and all data, information, advertisements, and |
| | etc. provided by the advertisers and other various |
| | resources. This includes but is not limited to legal |
| | information (i.e. regarding immigration, traffic, |
| | business, criminal, and etc.), food and restaurant, |
| | real-estate, transportation, entertainment, |
| | education, banks and financial resources, and etc. |
| AD-Options | Includes the various options available to those |
| | providing the “information of life,” |
| | including but not limited to the use of video, |
| | audio, photograph, graphics, text, and etc. |

### SUMMARY

In sum, this invention uses a CD-ROM to input advertisements and information provided by advertisers and various resources from a certain area and distributing the above said disc on an international aircraft and/or other vehicles, and providing access to the passengers en route to a certain area and/or country in a language familiar to the passengers.

### BACKGROUND

It is known that there are certain fixed range of numbers of travelers all around the world and cities. Especially in case of international airlines, the major group of passengers of a certain airline is most likely the citizens of the country that the airline belongs to. Among the major group of these passengers in the aircraft, consists of travelers for business, tour, study, visit, immigration, and etc. They are not easily adapted to the life in the city or country where they are going to. Upon arriving, they usually depend on the yellow-pages of that city where they have arrived, to get the necessary information that is of course if they are able to obtain the yellow-pages and if they know that such a thing exists. Advertising to the people who are on the way to the city where the advertisers' businesses are located before they land via a free and/or low cost CD-ROM, can have significant advertising success and benefits.

The people who are traveling to the foreign cities and/or countries most likely at least have some fear of their destination of travel. Language, law, food, transportation, and most activities are usually totally dependent on their acquaintances and/or encounters in that foreign area. By providing the essential information of life in that city and/or country via the CD-ROM in the airplane before landing, the passenger can invest their time during transportation to learn general information about the city where they are flying to.

Moreover, the passenger can use the information on the CD-ROM after landing by running a personal computer and/or transmitting the information to a cellular phone to get the information easily and quickly without time or place limitations, and without having to rely on another person.

In addition, a person with travel plans can access the website, with the option to download for the purpose of printing or transferring to another electronic device and/or discs, prior to and/or during travel to provide easy access to, and information of the foreign area.

Furthermore, the above can be accessed through various methods via the cellular phone, telephone, network, internet, mail, television broadcasting, electronic personal organizers, and etc.

### DESCRIPTION OF INVENTION

In the CD-ROM, the general format of the layout of categories is different from the conventional yellow-pages. Rather than providing the telephone numbers of businesses in town, this will provide essential and general information of the life in the town, city and/or country where they are staying, in addition to the contact information of businesses of interest in a language familiar to the viewer.

The category layout on the CD-ROM and website mainly contains the following categories: Legal aspects (especially including immigration, traffic, business and criminal), Food and Restaurant, Real-Estate, Transportation, Entertainment, Education, Banks and Financial resources, and etc.

The advertisers are provided with and guided to select several options for the advertisement of their business. Their selection consists of one or more of video advertisement, color picture with audio advertisement, color picture advertisement, and/or other general advertisement which contains the information of their business.

After receiving this CD-ROM in the aircraft, the passengers can open and operate this CD-ROM by running their portable computer and/or remote control attached to their seat in the aircraft while the airplane is running the CD-ROM from its main video and/or CD-ROM player system and/or travelers can access this via the internet website with the option of downloading for the purpose of printing, transferring to another electronic device and/or discs.

The passenger and/or user of this CD-ROM, and/or website can transmit the information on the CD-ROM and/or website to other electronic devices which can output the information.

What is claimed is:

1. A System and method(s) for marketing by providing information of life in an unfamiliar country and/or area, including but not limited to advertisements and information via CD-ROM in the airplane and/or other transportation vehicles, mainly but not limited to international aircrafts transporting international passengers en route to a new country destination.

2. The method(s) of claim 1 wherein the step of converting and organizing the contents and/or data of the information of life in a foreign country and/or area, and advertisement(s) provided by the advertisers and/or other resources, into various electronic format such as video, audio, picture, and etc. to save onto the CD-ROM and to distribute the CD-ROM in the airplane and/or other transportation vehicles in a language familiar to the passengers. When the data of information occupies a large amount of space on the disk, the concerned information is saved as a “ZIP” file and the automatic unzipping procedure is programmed on the CD-ROM to unzip it during the operation of the CD-ROM by the user.

3. An advertising method using 1) a CD-ROM that is distributed to the passengers in the airplane and/or other transportation vehicles and/or terminals for free and/or a low cost. According to the option in the CD-ROM, the passenger can select their section of interest and these sections will contain video, audio, picture, and/or text contents of the advertisements provided by the advertisers in the area of their destination.

4. An advertising method of playing a CD-ROM in the transportation vehicle during its operation to provide passengers with information of the life in the city and/or country of their destination; and/or by providing people with access to the website containing the above information, from anywhere, with the option to download for the purpose of printing and/or transferring to a cellular phone and/or other electronic device and/or discs, and etc.

5. The system of claim 4, wherein a given advertisement and/or information of life in foreign cities and/or countries can be optimized to fit with the capacity and system of cellular phones and/or any other electrical device, and by doing so, cellular phone users can access the information without connecting to the online system.
